(19) United States
(12) Patent Application Publication
(10) Pub. No.: US 2024/0357697 A1
(43) Pub. Date: Oct. 24, 2024

(54) COMMUNICATION METHOD AND USER EQUIPMENT

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 18/761,624

(22) Filed: Jul. 2, 2024

Related U.S. Application Data
(63) Continuation of application No. PCT/JP2022/047341, filed on Dec. 22, 2022.

(30) Foreign Application Priority Data
Jan. 6, 2022 (JP) 2022-001269

(51) Int. Cl. H04W 76/27

(52) U.S. Cl. CPC H04W 76/27

(57) ABSTRACT

A communication method according to a first aspect is a communication method performed by a user equipment in an RRC idle state or an RRC inactive state, the communication method including the steps of determining a cell reselection threshold value according to an intended network slice of the user equipment, measuring radio quality of a radio signal received by the user equipment from a network, and controlling cell reselection or cell selection according to a result of comparison between the measured radio quality and the cell reselection threshold value.

### RELATED APPLICATIONS

The present application is a continuation based on PCT Application No. PCT/JP2022/047341, filed on Dec. 22, 2022, which claims the benefit of Japanese Patent Application No. 2022-001269 filed on Jan. 6, 2022. The content of which is incorporated by reference herein in their entirety.

### TECHNICAL FIELD

The present disclosure relates to a communication method and a user equipment used in a mobile communication system.

### BACKGROUND

In specifications of the Third Generation Partnership Project (3GPP), which is a standardization project for mobile communication systems, Network Slicing has been defined (for example, see Non-Patent Document 1). Network slicing is a technique for configuring a network slice that is a virtual network by logically dividing a physical network constructed by a telecommunications carrier.

### CITATION LIST

### Non-Patent Literature

Non-Patent Document 1: 3GPP Technical Specification: TS38.300

### SUMMARY

A user equipment in a radio resource control (RRC) idle state or an RRC inactive state performs a cell reselection procedure. In the 3GPP, network slice-specific cell reselection that is a network slice-dependent cell reselection procedure is under study.

In such network slice-specific cell reselection, for example, it is assumed that the user equipment preferentially reselects (that is, camps on) a cell belonging to a frequency having a high frequency priority associated with an intended network slice that the user equipment wants to use (intended slice). However, a specific method of the network slice-specific cell reselection is not yet determined.

The present disclosure is to provide a communication method and a user equipment for facilitating network slice-specific cell reselection.

A communication method according to a first aspect is a communication method performed by a user equipment in an RRC idle state or an RRC inactive state, the communication method including the steps of determining a cell reselection threshold value according to an intended network slice of the user equipment, measuring radio quality of a radio signal received by the user equipment from a network, and controlling cell reselection or cell selection according to a result of comparison between the measured radio quality and the cell reselection threshold value.

A user equipment according to a second aspect is a user equipment performing cell reselection or cell selection in an RRC idle state or an RRC inactive state, the user equipment including a controller configured to perform processing of determining a cell reselection threshold value according to an intended network slice of the user equipment, measuring radio quality of a radio signal received by the user equipment from a network, and controlling cell reselection or cell selection according to a result of comparison between the measured radio quality and the cell reselection threshold value.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram for illustrating an overview of a cell reselection procedure.

FIG. 7 is a flowchart illustrating a schematic flow of a typical cell reselection procedure.

FIG. 8 is a diagram illustrating an example of network slicing.

FIG. 9 is a diagram illustrating an overview of network slice-specific cell reselection.

FIG. 10 is a diagram illustrating an example of network slice frequency information.

FIG. 11 is a diagram illustrating an example of network slice-specific cell reselection.

FIG. 12 is a diagram for illustrating an operation according to an embodiment.

FIG. 13 is a diagram illustrating an operation flow example of a UE according to an embodiment.

FIG. 14 is a diagram illustrating an operation of a UE according to a first variation.

FIG. 15 is a diagram illustrating an operation of a UE according to a third variation.

### DESCRIPTION OF EMBODIMENTS

A mobile communication system according to an embodiment is described with reference to the drawings. In the description of the drawings, the same or similar parts are denoted by the same or similar reference signs.

### Configuration of Mobile Communication System

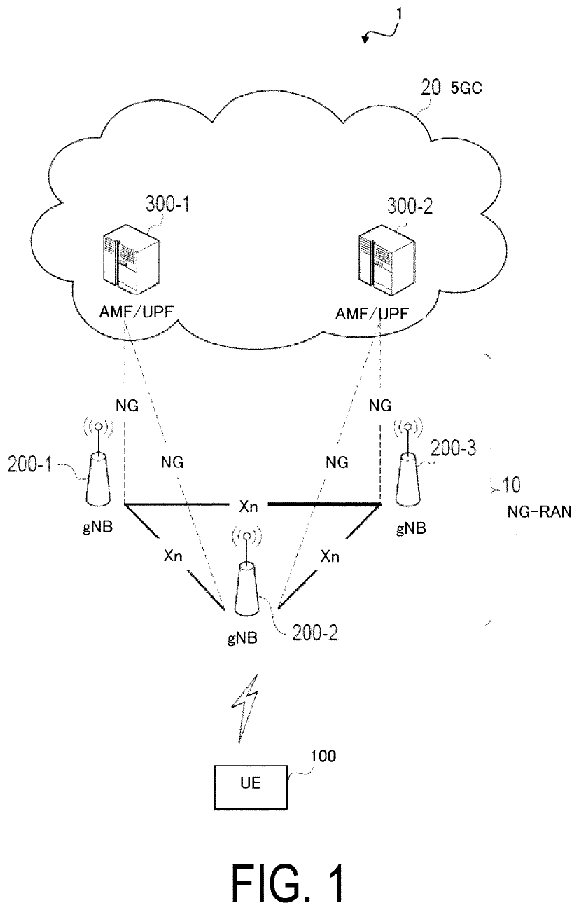

FIG. 1 is a diagram illustrating a configuration of a mobile communication system according to an embodiment. The mobile communication system 1 complies with the 5th Generation System (5GS) of the 3GPP standard. The description below takes the 5GS as an example, but a Long Term Evolution (LTE) system or a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

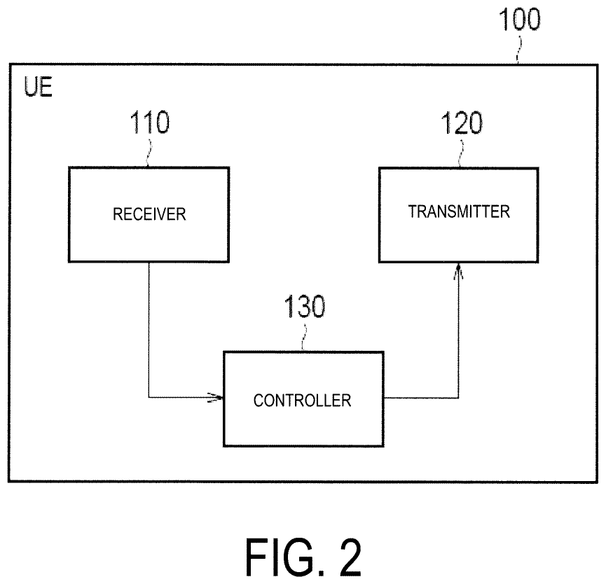

FIG. 2 is a diagram illustrating a configuration of the UE 100 (user equipment) to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

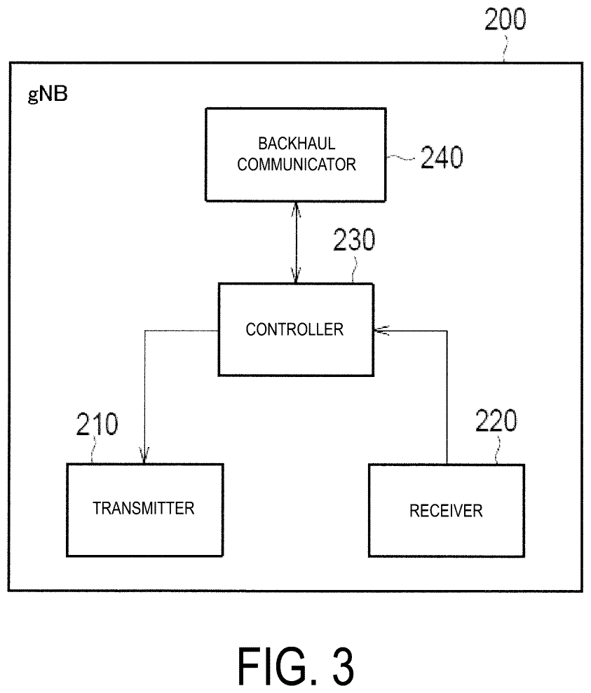

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

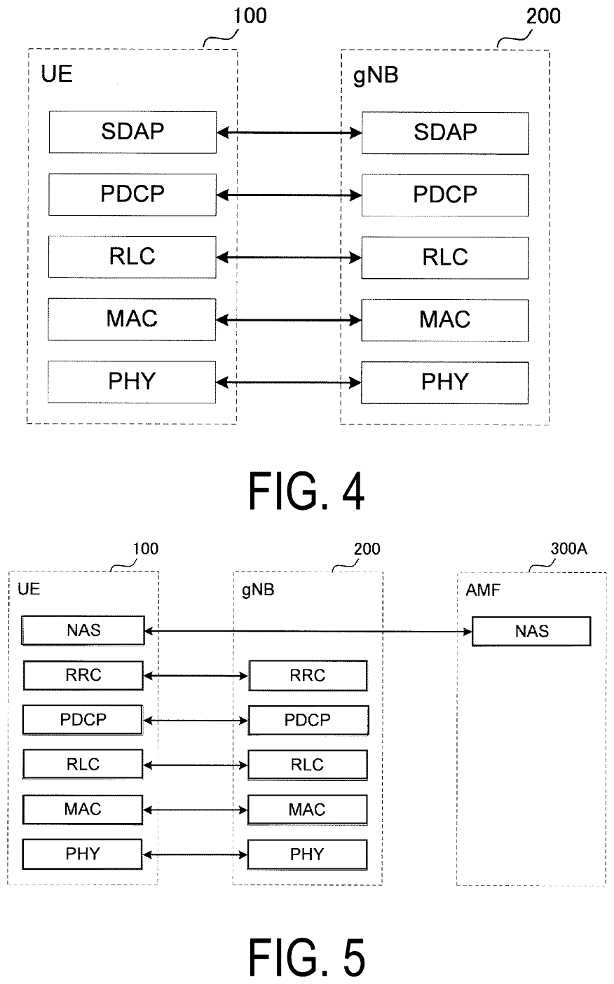

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as Access Stratum (AS).

### Overview of Cell Reselection Procedure

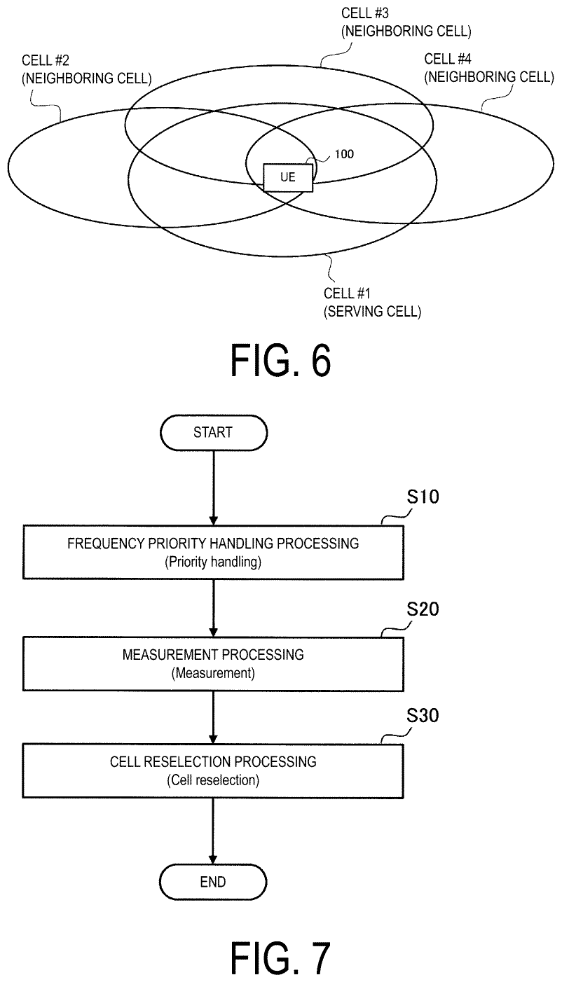

FIG. 6 is a diagram for illustrating an overview of a cell reselection procedure.

The UE 100 in the RRC idle state or the RRC inactive state performs the cell reselection procedure with moving to migrate from a current serving cell (cell #1) to a neighboring cell (any one of cells #2 to #4). To be more specific, the UE 100 specifies a neighboring cell to be camped by the UE 100 through the cell reselection procedure and reselects the specified neighboring cell. A case where the frequency (carrier frequency) is the same between the current serving cell and the neighboring cell is referred to as an intra-frequency, and a case where the frequency (carrier frequency) is different between the current serving cell and the neighboring cell is referred to as an inter-frequency. The current serving cell and the neighboring cell may be managed by the same gNB 200. The current serving cell and the neighboring cell may be managed by the gNBs 200 different from each other.

FIG. 7 is a flowchart illustrating a schematic flow of a typical cell reselection procedure.

In step S10, the UE 100 performs frequency priority handling processing based on frequency-specific priorities (also referred to as “absolute priorities”) specified by the gNB 200, for example, by way of a system information block or an RRC release message. To be more specific, the UE 100 manages the frequency priority designated by the gNB 200 for each frequency.

In step S20, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, cell defining-synchronization signal and PBCH block (CD-SSB). For example, the UE 100 continuously measures the radio quality for a frequency with a priority higher than the priority of the frequency of the current serving cell, and when the radio quality of the current serving cell is lower than a predetermined quality (cell reselection threshold value), the UE 100 measures the radio quality for a frequency with a priority equal to or lower than the priority of the frequency of the current serving cell.

In step S30, the UE 100 performs the cell reselection processing of reselecting a cell on which the UE 100 camps based on the measurement result in step S20. For example, the UE 100 may perform cell reselection to a neighboring cell when a priority of a frequency of the neighboring cell is higher than the priority of the current serving cell and when the neighboring cell satisfies a predetermined quality standard (i.e., a minimal quality standard) for a predetermined period of time. When the priories of the frequencies of the neighboring cells are the same as the priority of the current serving cell, the UE 100 may rank the radio qualities of the neighboring cells to perform cell reselection to the neighboring cell ranked higher than a rank of the current serving cell for a predetermined period of time. When the priority of the frequency of the neighboring cell is lower than the priority of the current serving cell, and when the radio quality of the current serving cell is lower than a certain threshold value (cell reselection threshold value) and the radio quality of the neighboring cell is continuously higher than another threshold value (cell reselection threshold value) for a predetermined period of time, the UE 100 may perform cell reselection to the neighboring cell. Overview of Network Slicing

The network slicing is a technique for virtually dividing a physical network (for example, a network including the NG-RAN 10 and the 5GC 20) constructed by an operator to create a plurality of virtual networks. Each virtual network is referred to as a network slice.

The network slicing allows a communication carrier to create network slices according to service requirements of different service types, such as enhanced Mobile Broadband (eMBB), Ultra-Reliable and Low Latency Communications (URLLC), and massive Machine Type Communications (mMTC), for example, to optimize network resources.

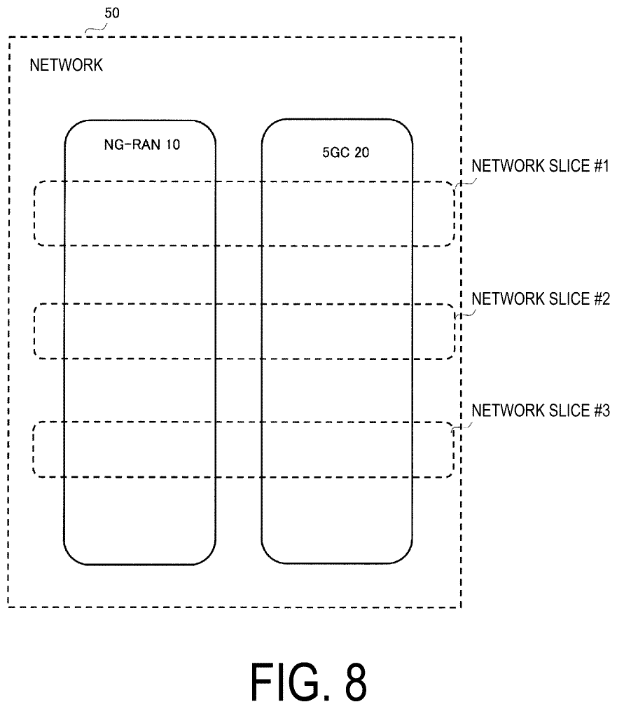

FIG. 8 is a diagram illustrating an example of the network slicing.

Three network slices (network slices #1 to #3) are configured on a network 50 including the NG-RAN 10 and the 5GC 20. The network slice #1 is associated with a service type of eMBB, the network slice #2 is associated with a service type of URLLC, and the network slice #3 is associated with a service type of mMTC. Note that three or more network slices may be configured on the network 50. One service type may be associated with a plurality network slices.

Each network slice is provided with a network slice identifier for identifying the network slice. Examples of the network slice identifier include a Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a network slice is associated. The SD is information for differentiating a plurality of network slices associated with the same service type. The information including a plurality of pieces of S-NSSAI is referred to as a Network Slice Selection Assistance Information (NSSAI).

One or more network slices may be grouped to configure a network slice group. The network slice group is a group including one or more network slices, and a network slice group identifier is assigned to the network slice group. The network slice group may be configured by the core network (for example, the AMF 300), or may be configured by the radio access network (for example, the gNB 200). The UE 100 may be notified of the configured network slice group.

Hereinafter, the term “network slice” may refer to S-NSSAI that is an identifier of a single network slice or NSSAI that is a collection of pieces of S-NSSAI. The term “network slice” may refer to a network slice group that is a group of one or more pieces of S-NSSAI or NSSAI.

The UE 100 also determines an intended network slice that the UE 100 wants to use. Such an intended network slice may be referred to as an intended slice. In the embodiment, the UE 100 determines a network slice priority for each network slice (intended network slice). For example, the NAS of the UE 100 determines the network slice priority based on an operation status of an application in the UE 100 and/or a user operation/setting, and notifies the AS of the determined network slice priority.

### Example of Network Slice-Specific Cell Reselection

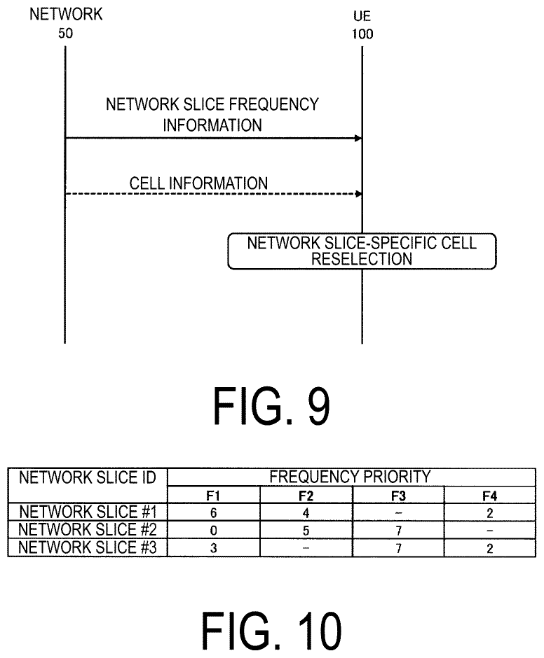

FIG. 9 is a diagram illustrating an example of network slice-specific cell reselection.

In the network slice-specific cell reselection, the UE 100 performs cell reselection processing based on network slice frequency information provided from the network 50. The network slice frequency information may be provided from the gNB 200 to the UE 100 through broadcast signaling (for example, a system information block) or dedicated signaling (for example, an RRC release message).

The network slice frequency information is information indicating a correspondence relationship between network slices, frequencies, and frequency priorities. For example, the network slice frequency information indicates, for each network slice (or network slice group), a frequency (one or more frequencies) supporting the network slice and a frequency priority assigned to each frequency. An example of the network slice frequency information is illustrated in FIG. 10.

In the example illustrated in FIG. 10, three frequencies F1, F2, and F4 are associated with the network slice #1 as frequencies supporting the network slice #1. Among these three frequencies, the frequency priority of F1 is “6”, the frequency priority of F2 is “4”, and the frequency priority of F4 is “2”. In the example of FIG. 10, the larger the number of the frequency priority, the higher the priority is, but a case in which the smaller the number, the higher the priority is may also be possible.

Three frequencies F1, F2, and F3 are associated with the network slice #2 as frequencies supporting the network slice #2. Among these three frequencies, the frequency priority of F1 is “0”, the frequency priority of F2 is “5”, and the frequency priority of F3 is “7”.

Three frequencies F1, F3, and F4 are associated with the network slice #3 as frequencies supporting the network slice #3. Among these three frequencies, the frequency priority of F1 is “3”, the frequency priority of F3 is “7”, and the frequency priority of F4 is “2”.

Hereinafter, the frequency priority indicated in the network slice frequency information may be referred to as a “network slice-specific frequency priority” in order to be distinguished from an absolute priority in a conventional cell reselection procedure.

The UE 100 may perform the cell reselection processing further based on cell information provided from the network 50. The cell information may be information indicating a correspondence relationship between a cell (for example, a serving cell and each neighboring cell) and a network slice that is not provided or provided by the cell. For example, a cell may temporarily fail to provide some or all network slices due to congestion or the like. That is, even for a network slice support frequency capable of providing a network slice, some cells within the frequency may not provide the network slice. Based on the cell information, the UE 100 may grasp which network slice is not provided by each cell. The cell information like this may be provided from the gNB 200 to the UE 100 through broadcast signaling (for example, a system information block) or dedicated signaling (for example, an RRC release message).

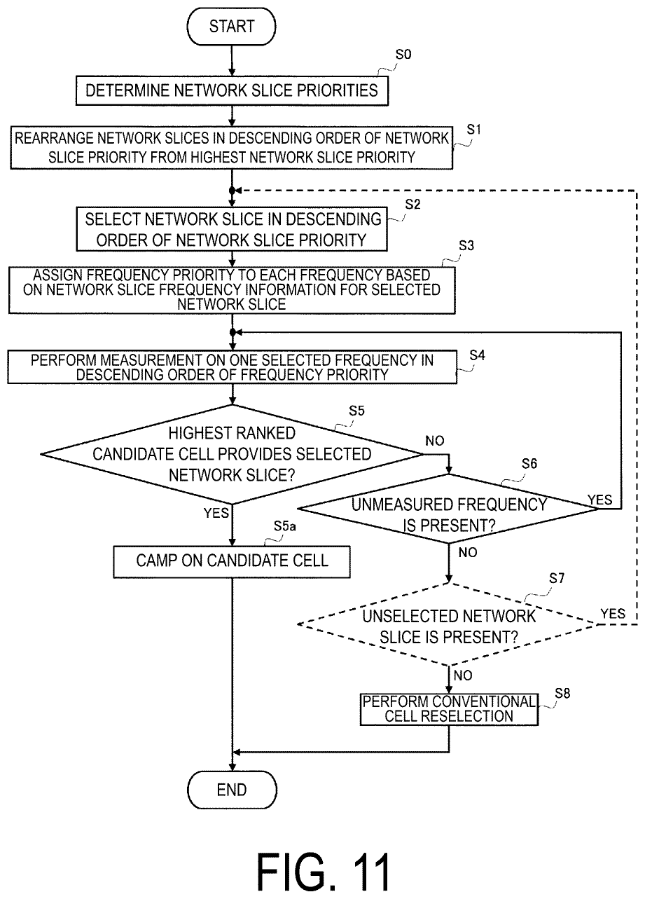

FIG. 11 is a diagram illustrating an example of the network slice-specific cell reselection. Before starting the network slice-specific cell reselection, the UE 100 is assumed to be in the RRC idle state or the RRC inactive state, and to receive and retain the above-mentioned network slice frequency information.

In step S0, the NAS of UE 100 determines the network slice identifiers of the intended network slices of the UE 100 and the network slice priorities of the intended network slices, and notifies the AS of the UE 100 of network slice information including the determined network slice priorities. The “intended network slices” each include a network slice that is likely to be used, a candidate network slice, a wanted network slice, a network slice with which communication is desired, a requested network slice, an allowed network slice, or a planned network slice. For example, the network slice priority of the network slice #1 is determined to be “3”, the network slice priority of the network slice #2 is determined to be “2”, and the network slice priority of the network slice #3 is determined to be “1”. The larger the number of the network slice priority, the higher the priority is, but a case in which the smaller the number, the higher the priority is may also be possible.

In step S1, the AS of the UE 100 rearranges the network slices (network slice identifiers), the AS of which is notified by the NAS in step S0, in descending order of network slice priority. A list of the network slices arranged in this manner is referred to as a “network slice list”.

In step S2, the AS of the UE 100 selects one network slice in descending order of network slice priority. The network slice selected in this manner is referred to as a “selected network slice”.

In step S3, the AS of the UE 100 assigns, for the selected network slice, a frequency priority to each of the frequencies associated with that network slice. Specifically, the AS of the UE 100 specifies frequencies associated with the network slice based on the network slice frequency information and assigns frequency priorities to the specified frequencies. For example, when the selected network slice selected in step S2 is the network slice #1, the AS of the UE 100 assigns the frequency priority “6” to the frequency F1, the frequency priority “4” to the frequency F2, and the frequency priority “2” to the frequency F4 according to the network slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs the measurement processing on the selected frequency. The frequency selected in this manner is referred to as a “selected frequency”. The AS of the UE 100 may rank the cells measured within the selected frequency in descending order of radio quality. Among the cells measured within the selected frequency, those cells that satisfy a predetermined quality standard (i.e., a minimal quality standard) are referred to as “candidate cells”.

In step S5, the AS of the UE 100 specifies a cell ranked the highest based on the result of the measurement processing in step S4, and determines whether the cell provides the selected network slice based on the cell information. When determining that the highest ranked cell provides the selected network slice (step S5: YES), the AS of the UE 100 reselects the highest ranked cell and camps on that cell in step S5a.

On the other hand, when determining that the highest ranked cell does not provide the selected network slice (step S5: NO), the AS of UE 100 determines in step S6 whether a frequency not measured is present in the frequency list created in step S3. When determining that a frequency not measured is present (step S6: YES), the AS of the UE 100 resumes the processing for the frequency having the next highest frequency priority, and performs the measurement processing by use of that frequency as selected frequency (returns the processing to step S4).

When determining that a frequency not measured is not present in the frequency list created in step S3 (step S6: NO), the AS of the UE 100 may determine in step S7 whether an unselected network slice is present in the network slice list created in step S1. When determining that an unselected network slice is present (step S7: YES), the AS of the UE 100 resumes the processing for the network slice having the next highest network slice priority, and selects that network slice as the selected network slice (returns the processing to step S2). Note that in the example illustrated in FIG. 11, the processing in step S7 may be omitted.

When determining that an unselected network slice is not present (step S7: NO), the AS of the UE 100 performs conventional cell reselection processing in step S8. The conventional cell reselection processing may mean an entirety of a general cell reselection procedure illustrated in FIG. 7. The conventional cell reselection processing may also mean only cell reselection processing (step S30) illustrated in FIG. 7. In the latter case, the UE 100 may use the measurement result in step S4 without measuring the radio qualities of the cells again.

In such network slice-specific cell reselection, the UE 100 may receive, from the serving cell, cell information indicating a network slice supported by a neighboring cell. In the case of intra-frequency cell reselection, the UE 100 may camp on a cell with the best radio quality according to the existing “Best cell principle”. The network 50 may broadcast slice information (network slice frequency information) for the purpose of inter-frequency cell reselection.

Note that, in the example of the network slice-specific cell reselection described above, only the network slice-specific frequency priority is first applied and then the absolute priority in the conventional cell reselection procedure (hereinafter referred to as “legacy frequency priority”) is applied. However, the network slice-specific frequency priority may be always prioritized over the legacy frequency priority.

### Operation according to Embodiment

In the example of the network slice-specific cell reselection described above, the network slice-specific frequency priority is introduced in the frequency priority handling processing (Priority handling), which makes it easy for the UE 100 to camp on a cell providing the intended network slice. However, a radio quality threshold value for defining a condition for performing measurement of a neighboring cell, a radio quality threshold value for defining a condition for performing cell reselection to the neighboring cell, and the like are the same as conventional values. Hereinafter, the radio quality threshold value used for cell reselection is referred to as a “cell reselection threshold value”. Note that the radio quality refers to reception power and/or reception quality such as reception power and/or reception quality of a reference signal received from the serving cell and/or the neighboring cell.

A conventional cell reselection threshold value is configured in the UE 100 by using a system information block from the network 50. Specifically, a cell reselection threshold value commonly used for intra-frequency cell reselection and inter-frequency cell reselection is configured in the UE 100 by using a system information block type 2 (SIB2) from the serving cell. A cell reselection threshold value used for intra-frequency cell reselection is configured in the UE 100 by using a system information block type 3 (SIB3) from the serving cell. A cell reselection threshold value used for inter-frequency cell reselection is configured in the UE 100 for each neighboring frequency by using a system information block type 4 (SIB4) from the serving cell. When such a conventional cell reselection threshold value is used, it is not possible to perform detailed cell reselection control according to the properties (service requirements) of each network slice. That is, in the example of the network slice-specific cell reselection described above, the cell reselection threshold value independent of the network slice is used as it is as in the conventional art. Thus, both the UE 100 that wants to perform network slice communication and the UE 100 that wants to perform conventional communication use the same cell reselection threshold value. The present disclosure provides a communication method and a user equipment including a method of newly adding a threshold value for a network slice to these threshold values, thereby facilitating network slice-specific cell reselection.

In the embodiment, the UE 100 in the RRC idle state or the RRC inactive state determines a cell reselection threshold value according to its own intended network slice, measures the radio quality of a radio signal received from the network 50, and controls cell reselection according to a result of comparison between the measured radio quality and the cell reselection threshold value. In this way, the UE 100 determines the cell reselection threshold value according to its own intended network slice, so that it is possible to perform cell reselection control using the cell reselection threshold value according to the intended network slice. This can facilitate the network slice-specific cell reselection. In the following, such a cell reselection threshold value is referred to as a “network slice-specific cell reselection threshold value”. The network slice-specific cell reselection threshold value may be applied only to the UE 100 having the intended network slice. The UE 100 having the intended network slice may control cell reselection using the network slice-specific cell reselection threshold value instead of the conventional cell reselection threshold value (i.e., network slice-independent cell reselection threshold value).

In the embodiment, the cell reselection threshold value determined according to the intended network slice may be a threshold value to be compared with the radio quality of the serving cell. The UE 100 may perform measurement on an intra-frequency and/or inter-frequency neighboring cell in response to the radio quality of the serving cell being lower than the cell reselection threshold value determined according to the intended network slice. Such a cell reselection threshold value may be, for example, at least one selected from the group consisting of S_{IntraSearchP}, S_{IntraSearchQ}, S_{nonIntraSearchP}, and S_{nonIntraSearchQ}. The UE 100 may perform measurement of an intra-frequency neighboring cell when the reception power of the serving cell falls below S_{IntraSearchP}. The UE 100 may perform measurement of an intra-frequency neighboring cell when the reception quality of the serving cell falls below S_{IntraSearchQ}. The UE 100 may perform measurement of an inter-frequency neighboring cell when the reception power of the serving cell falls below S_{nonIntraSearchP}. The UE 100 may perform measurement of an inter-frequency neighboring cell when the reception quality of the serving cell falls below S_{nonIntraSearchQ}.

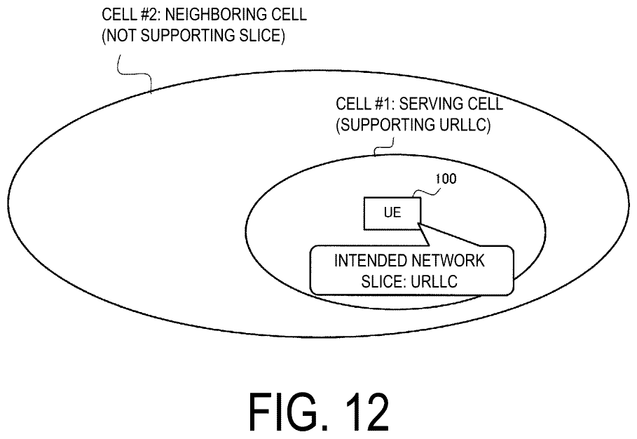

Here, a specific example will be described with reference to FIG. 12. The UE 100 in the RRC idle state or the RRC inactive state camps on a cell #1 as the serving cell of the UE 100. The intended network slice of the UE 100 is URLLC, and the cell #1 supports URLLC. On the other hand, a cell #2 (neighboring cell) covering the cell #1 does not support any network slice. In such a situation, by maintaining the serving cell of the UE 100 to be the cell #1, it is possible to perform communication of URLLC when the UE 100 has transitioned to the RRC connected state. Thus, the UE 100 may determine at least one selected from the group consisting of S_{IntraSearchP}, S_{IntraSearchQ}, S_{nonIntraSearchP}, and S_{nonIntraSearchQ} as the network slice-specific cell reselection threshold value to be lower than the conventional cell reselection threshold value (network slice-independent cell reselection threshold value). Use of such a low cell reselection threshold value can make it difficult for the UE 100 to perform measurement on the cell #2 (neighboring cell). This facilitates maintaining the serving cell of the UE 100 to be the cell #1. This can reduce the power of the UE 100 consumed due to the measurement.

In the embodiment, in the case of inter-frequency, the cell reselection threshold value determined according to the intended network slice may be a threshold value to be compared with the radio quality of a neighboring cell. The UE 100 may perform cell reselection to a neighboring cell in response to the radio quality of the neighboring cell being higher than the cell reselection threshold value determined according to the intended network slice. Such a cell reselection threshold value may be, for example, at least one selected from the group consisting of Thresh_{X, HighP}, Thresh_{X, HighQ}, Thresh_{X, LowP}, and Thresh_{X, LowQ}. The UE 100 may perform cell reselection to a neighboring cell having a higher frequency priority than the serving cell in response to the reception power of the neighboring cell exceeding Thresh_{X, HighP}. The UE 100 may perform cell reselection to a neighboring cell having a higher frequency priority than the serving cell in response to the reception quality of the neighboring cell exceeding Thresh_{X, HighQ}. The UE 100 may perform cell reselection to a neighboring cell having a lower frequency priority than the serving cell in response to the reception power of the neighboring cell exceeding Thresh_{X, LowP}. The UE 100 may perform cell reselection to a neighboring cell having a lower frequency priority than the serving cell in response to the reception quality of the neighboring cells exceeding Thresh_{X, LowQ}.

In the example of FIG. 12, when the frequencies of the cell #1 and the cell #2 are different from each other, the UE 100 may determine at least one selected from the group consisting of Thresh_{X, HighP}, Thresh_{X, HighQ}, Thresh_{X, LowP}, and Thresh_{X, LowQ} as the network slice-specific cell reselection threshold value to be higher than the conventional cell reselection threshold value (network slice-independent cell reselection threshold value). Use of such a high cell reselection threshold value can make it difficult for the UE 100 to perform cell reselection to the cell #2 (neighboring cell). This facilitates maintaining the serving cell of the UE 100 to be the cell #1.

In the embodiment, in the case of inter-frequency, the cell reselection threshold value determined according to the intended network slice may be a threshold value to be compared with the radio quality of the serving cell. The UE 100 may perform cell reselection to a neighboring cell in response to the radio quality of the serving cell being lower than the cell reselection threshold value determined according to the intended network slice. Such a cell reselection threshold value may be, for example, at least one selected from the group consisting of Thresh_{Serving, LowP} and Thresh_{Serving, LowQ}. The UE 100 may perform cell reselection to a neighboring cell having a lower frequency priority than the serving cell in response to the reception power of the serving cell falling below Thresh_{Serving, LowP}. The UE 100 may perform cell reselection to a neighboring cell having a lower frequency priority than the serving cell in response to the reception quality of the serving cell falling below Thresh_{Serving, LowQ}.

In the example of FIG. 12, when the frequencies of the cell #1 and the cell #2 are different from each other, the UE 100 may determine at least one selected from the group consisting of Thresh_{Serving, LowP} and Thresh_{Serving, Low} as the network slice-specific cell reselection threshold value to be lower than the conventional cell reselection threshold value (network slice-independent cell reselection threshold value). Use of such a low cell reselection threshold value can make it difficult for the UE 100 to perform cell reselection to the cell #2 (neighboring cell). This facilitates maintaining the serving cell of the UE 100 to be the cell #1.

The cell reselection threshold value determined according to the intended network slice is not limited to a threshold value of radio quality, but may be a threshold value of a time. The UE 100 may perform inter-frequency cell reselection in response to a duration for which a threshold value condition as described above is satisfied exceeding a threshold value. Such a cell reselection threshold value may be, for example, Treselection_{RAT}.

In the example of FIG. 12, when the frequencies of the cell #1 and the cell #2 are different from each other, the UE 100 may determine Treselection_{RAT} as the network slice-specific cell reselection threshold value to be longer than the conventional cell reselection threshold value (network slice-independent cell reselection threshold value). Use of such a long cell reselection threshold value can make it difficult for the UE 100 to perform cell reselection to the cell #2 (neighboring cell). This facilitates maintaining the serving cell of the UE 100 to be the cell #1.

In this way, the UE 100 determines the cell reselection threshold value according to its own intended network slice, and thus the UE 100 can easily camp on a cell providing the intended network slice. However, if the UE 100 can freely determine the cell reselection threshold value without restriction, a contradiction with the cell design of the network may arise, and cell reselection control and management of the network also becomes difficult.

Thus, in the embodiment, the UE 100 may receive configuration information for determining the network slice-specific cell reselection threshold value from the network 50 (serving cell) and determine the cell reselection threshold value according to the intended network slice using the received configuration information. This facilitates cell reselection control and management of the network.

In the embodiment, the configuration information includes a plurality of network slice-specific parameters associated with respective different network slices. The UE 100 may determine the cell reselection threshold value using the network slice-specific parameter associated with the intended network slice among the plurality of network slice-specific parameters. This makes it easy to use, for each network slice, the network slice-specific cell reselection threshold value according to the properties (service requirements) of the network slice. For example, the cell reselection threshold value may be configured such that higher radio qualities are required for URLLC and eMBB than for mMTC. The cell reselection threshold value may be configured such that a more stable radio quality is required for URLLC than for other network slices.

Here, each of the plurality of network slice-specific parameters included in the configuration information may include the network slice-specific cell reselection threshold value. That is, the network 50 (gNB 200) may transmit, to the UE 100, the configuration information including the cell reselection threshold value for each network slice.

Alternatively, each of the plurality of network slice-specific parameters may include a network slice-specific offset value. The network slice-specific cell reselection threshold value may be configured by applying the offset value to the conventional cell reselection threshold value (network slice-independent cell reselection threshold value). That is, for each network slice, the UE 100 is notified of the difference (offset value) between the network slice-independent cell reselection threshold value and the network slice-specific cell reselection threshold value. Then, the UE 100 applies, for each network slice, the offset value to the network slice-independent cell reselection threshold value to calculate the network slice-specific cell reselection threshold value.

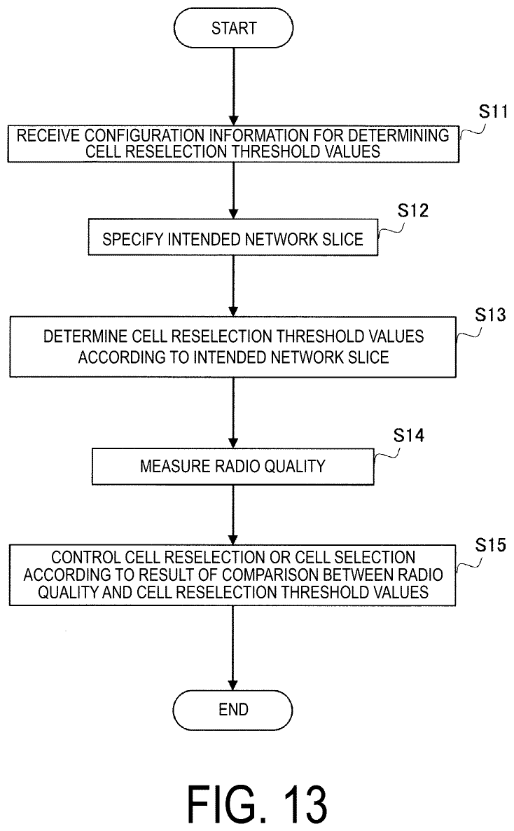

FIG. 13 is a diagram illustrating an operation flow example of the UE 100 according to the embodiment.

In step S11, the UE 100 (AS) receives, from the serving cell of the network 50 (gNB 200), configuration information including a plurality of network slice-specific parameters associated with respective different network slices. Here, it is assumed that each of the plurality of network slice-specific parameters includes a network slice-specific cell reselection threshold value. For example, when the total number of network slices is four, the configuration information includes four sets of cell reselection threshold values.

At least one selected from the group consisting of SIB2, SIB3, and SIB4 may include the configuration information. An RRC Release, which is a UE-dedicated message for causing the UE 100 to transition to the RRC idle state or RRC inactive state, may include the configuration information. Alternatively, the configuration information may be stored in the UE 100 or a Universal Subscriber Identity Module (USIM). That is, the configuration information predetermined by the operator may be stored in the UE 100 or the USIM.

In step S12, the UE 100 (AS) specifies its own intended network slice. As described above, the AS of the UE 100 may acquire information of the intended network slice (for example, network slice information including the network slice priority) from its own NAS. At this time, the AS of the UE 100 may query the NAS. Here, when a plurality of intended network slices are present, a network slice with the highest priority may be specified as the intended network slice based on the network slice priority. For example, when the network slice priority of eMBB is “7” and the network slice priority of URLLC is “5”, the AS of the UE 100 specifies eMBB as the intended network slice. Note that the AS of the UE 100 may notify the NAS of the type of its own cell reselection threshold value (network slice-specific cell reselection threshold value or network slice-independent cell reselection threshold value). When using the network slice-specific cell reselection threshold value, the AS of the UE 100 may notify the NAS of at least one selected from the group consisting of the network slice type and its priority type (quality first, etc.).

Here, when camping on a cell supporting one of the plurality of intended network slices, the UE 100 may specify this one network slice as the intended network slice. When a PDU session corresponding to any network slice is pending (CM_CONNECTED, RRC INACTIVE), the UE 100 may specify this network slice corresponding to the PDU session as the intended network slice.

Note that step S12 may be performed before step S11. This flow may be performed only when the UE 100 has the intended network slice.

In step S13, the UE 100 (AS) determines a set of cell reselection threshold values (network slice-specific cell reselection threshold values) corresponding to the intended network slice specified in step S12 from among the plurality of sets of cell reselection threshold values received in step S11. Specifically, when the set of cell reselection threshold values (network slice-specific cell reselection threshold values) corresponding to the intended network slice specified in step S12 is provided from the gNB 200 (when the set has already been received), the UE 100 (AS) applies the set. When the set is not provided from the gNB 200, the UE 100 (AS) may apply normal cell reselection threshold values (cell-specific set rather than network slice-specific set).

In step S14, the UE 100 measures radio quality. The UE 100 may measure at least the radio quality of the serving cell. The UE 100 may measure the radio qualities of the serving cell and each of the neighboring cells.

In step S15, the UE 100 compares the radio quality measured in step S14 with the cell reselection threshold values determined in step S13, and controls cell reselection according to the comparison result.

### First Variation

Although an example in which the UE 100 specifies one intended network slice has been described in the above embodiment, the UE 100 may specify two or more intended network slices. When having two or more intended network slices, the UE 100 may determine cell reselection threshold values (network slice-specific cell reselection threshold values) using two or more network slice-specific parameters corresponding to the two or more intended network slices. This enables cell reselection control taking into account the service requirements of various network slices.

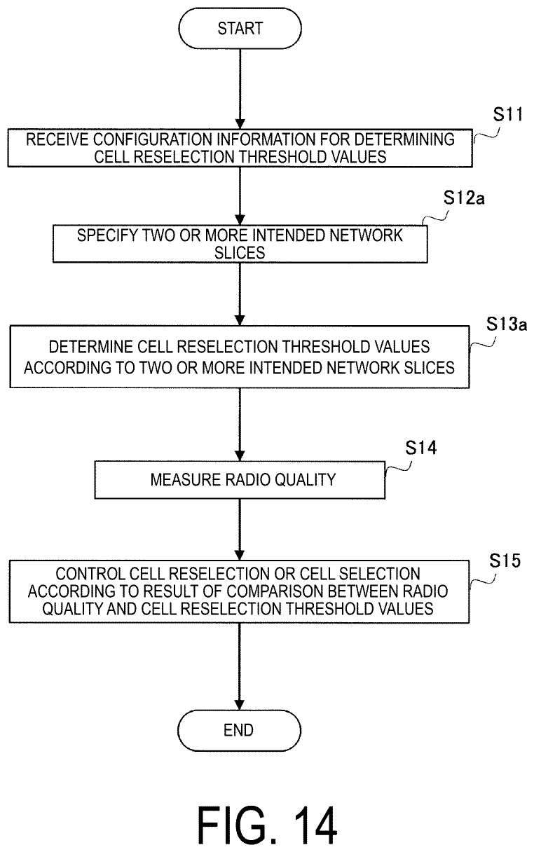

FIG. 14 is a diagram illustrating an operation of the UE 100 according to the present variation. Here, differences from the operation flow example of the embodiment described above will be described.

In step S12a, the UE 100 (AS) specifies two or more intended network slices. The AS of the UE 100 may acquire information of the intended network slices (for example, network slice information including network slice priorities) from its own NAS and specify the two or more intended network slices based on this information.

In step S13a, the UE 100 (AS) determines, based on the plurality of sets of cell reselection threshold values received in step S11, two or more sets of cell reselection threshold values (network slice-specific cell reselection threshold values) corresponding to the two or more intended network slices specified in step S12a.

The UE 100 (AS) may adopt values of the network slice with the most stringent conditions among the two or more intended network slices. For example, when the two or more intended network slices are URLLC and MIoT, S_{IntraSearchP} of URLLC is −140, S_{IntraSearchQ} of URLLC is −40, S_{IntraSearchP} of MIoT is −100, and S_{IntraSearchQ} of MIoT is −20, S_{IntraSearchP} may be determined to be −140 and S_{IntraSearchQ} may be determined to be −40. Alternatively, the values of the network slice with the loosest conditions among the two or more intended network slices may be adopted.

The UE 100 (AS) may take intermediate values (averages) among the two or more intended network slices. For example, when S_{IntraSearchP} of URLLC is −140, S_{IntraSearchQ}) of URLLC is −40, S_{IntraSearchP} of MIoT is −100, and S_{IntraSearchQ} of MIoT is −20, S_{IntraSearchP} may be determined to be −120 and S_{IntraSearchQ} may be determined to be −30.

The UE 100 (AS) may determine values according to its purpose. For example, S_{IntraSearchP} of URLLC is −140, S_{IntraSearchQ} of URLLC is −40, S_{IntraSearchP} of MIoT is −100, S_{IntraSearchQ} of MIoT is −20, and the purpose of the network slice in the UE 100 is to make quality first and make coverage first, S_{IntraSearchP} may be determined to be −100 and S_{IntraSearchQ} may be determined to be −40.

### Second Variation

The cell reselection threshold values include a threshold value available for cell selection at the time of turning on the UE 100 or the like. Thus, the cell reselection threshold value determined according to the intended network slice may be applied not only to cell reselection but also to cell selection. This facilitates cell reselection to a cell providing the intended network slice.

Examples of the cell reselection threshold value available for cell selection include a threshold value for defining a minimum radio quality required to camp on a cell. Such a threshold value may be at least one selected from the group consisting of Qᵣₓₗₑᵥₘᵢₙ, which is the minimum reception power required in the cell, Q_{rxlevminoffset}, which is an offset value for Qᵣₓₗₑᵥₘᵢₙ, Q_{qualmin}, which is the minimum reception quality required in the cell, Q_{qualminoffset}, which is an offset value for Q_{qualmin}, and Q_{offsettemp}, which is an offset value for Q_{qualmin} and is temporarily used in the cell.

### Third Variation

In the above-described embodiment, when the cell reselection threshold value is provided to the UE 100 for each network slice, the number of cell reselection threshold values provided to the UE 100 increases as the number of network slices (network slice types) increases. This may decrease signaling efficiency and take up a large amount of signaling capacity.

For example, four types of network slices are defined in the SST, and the number of types of network slices is considered to be infinite in consideration of operator's unique network slice specifications not defined in the SST. On the other hand, when the UE 100 freely determines the cell reselection threshold value, cell reselection does not reflect a cell coverage plan and a quality assurance plan of the operator, and the service quality may be degraded.

In the present variation, the configuration information transmitted from the serving cell of the network 50 (gNB 200) to the UE 100 includes a representative value for defining a range of a cell reselection threshold value that can be determined by the UE 100. The UE 100 determines the network slice-specific cell reselection threshold value within the range defined by the representative value according to the intended network slice. Thus, since the UE 100 determines the cell reselection threshold value within the range allowed by the operator, at least the minimal quality intended by the operator can be satisfied.

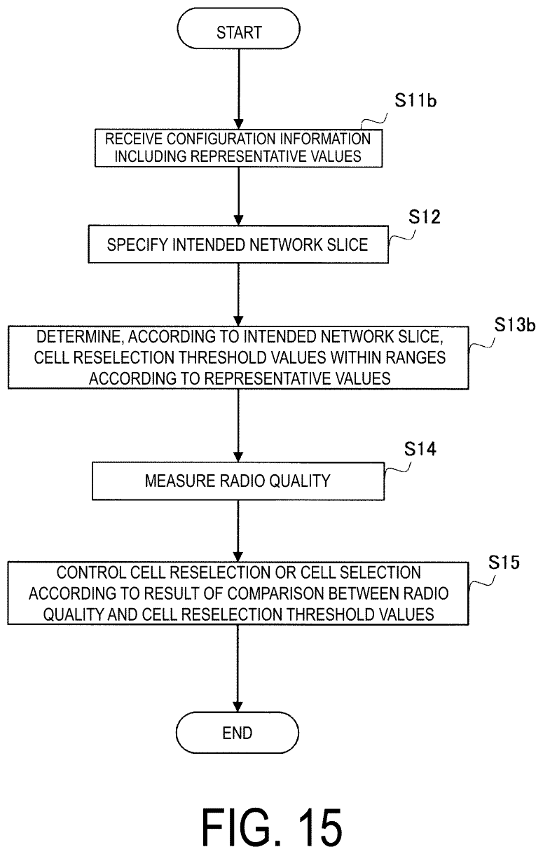

FIG. 15 is a diagram illustrating an operation of the UE 100 according to the present variation. Here, differences from the operation flow example of the embodiment described above will be described.

In step S11b, the UE 100 (AS) receives, from the serving cell of the network 50 (gNB 200), configuration information including a representative value for determining a range of a cell reselection threshold value that can be determined by the UE 100. Alternatively, the configuration information may be stored in the UE 100 or a Universal Subscriber Identity Module (USIM). That is, the configuration information predetermined by the operator may be stored in the UE 100 or the USIM. The representative value may be at least one selected from the group consisting of a maximum value and a minimum value. The representative value may be an intermediate value of the range of the cell reselection threshold value that can be determined by the UE 100. In this case, the range of the cell reselection threshold value that can be determined by the UE 100 may be a range of ±α (value determined in the specification) with reference to the intermediate value. Hereinafter, an example in which the representative values are the maximum value and the minimum value will be described. For example, the representative values of S_{IntraSearchP} and S_{IntraSearchQ} may be as follows:

$${S}_{IntraSearchP \_ SliceMAX} = - 140 , {S}_{IntraSearchP \_ SliceMIN} = - 100 \\ {S}_{IntraSearchQ \_ SliceMAX} = - 40 , {S}_{IntraSearchQ \_ SliceMIN} = - 10.$$

Alternatively, as described below, the network slice-independent cell reselection threshold value (hereinafter referred to as “Legacy” as appropriate) may be set to a minimum/maximum value, or a Legacy value may be set between the maximum value and the minimum value.

$${S}_{IntraSearchP \_ SliceMAX} = - 140 , \\ {S}_{IntraSearchP \_ SliceMIN} = {S}_{IntraSearchP} ( Legacy ) = - 100 \\ {S}_{IntraSearchQ \_ SliceMAX} = - 40 , \\ {S}_{IntraSearchQ} ( Legacy ) = - 20 , {S}_{IntraSearchQ \_ SliceMIN} = - 10$$

In step S13b, the UE 100 (AS) determines, according to the intended network slice, network slice-specific cell reselection threshold values within the ranges defined by the representative values. For example, when S_{IntraSearchP_SliceMAX} is −140, S_{IntraSearchP_SliceMIN} is −100, S_{IntraSearchQ_SliceMAX} is −40, and S_{IntraSearchQ_SliceMIN} is −10, the UE 100 may determine S_{IntraSearchP_Slice} to be −123 and S_{IntraSearchQ_Slice} to be −23.

### Fourth Variation

When determining a network slice-specific cell reselection threshold value, the UE 100 may consider whether the serving cell and/or a neighboring cell supports the intended network slice. For example, it may be difficult to perform cell reselection if the UE 100 continuously uses the cell reselection threshold value associated with the intended network slice even though no surrounding cells support the intended network slice.

In the present variation, the UE 100 (AS) receives, from the network 50 (gNB 200), support information (cell information) indicating a network slice supported by the serving cell and/or a network slice supported by the neighboring cell. The UE 100 (AS) determines the cell reselection threshold value according to the intended network slice and the support information. Specifically, the UE 100 (AS) compares the network slice supported by each of the serving cell and the neighboring cell with the intended network slice and adjusts the cell reselection threshold value according to whether the network slice is supported.

As a first example, it is assumed that the UE 100 the intended network slices of which are URLLC and eMBB performs a cell reselection operation from a cell A (supported network slices: URLLC and eMBB) to a cell B (supported network slice: eMBB). In this case, the UE 100 may change the cell reselection threshold value from the cell reselection threshold value of URLLC to the cell reselection threshold value of eMBB. This is because inconvenience such as difficulty in cell reselection may occur if the cell reselection threshold value of URLLC is applied to the cell B.

As a second example, it is assumed that while the UE 100, the intended network slice of which is URLLC, camps on a cell A (supported network slice: URLLC), a network slice supported by neighboring cells C and D changes from “none” to “URLLC”. In this case, the UE 100 may apply the cell reselection threshold value of URLLC to the cell reselection threshold values of the neighboring cells C and D. Here, the cell reselection threshold value of the neighboring cell refers to the above-described Thresh_{X, HighQ} or the like. Alternatively, the UE 100 may apply the cell reselection threshold value of the intended network slice to all neighboring cells even if the neighboring cells do not support the network slice.

As a third example, it is assumed that while the UE 100 the intended network slice of which is URLLC camps on a cell A (supported network slice: URLLC), a network slice supported by the cell A changes from “URLLC” to “none”. In this case, the UE 100 may apply the cell reselection threshold value of Legacy to the cell reselection threshold value of the serving cell.

As a fourth example, it is assumed that, in a situation where a first-priority intended network slice of the UE 100 is V2X and a second-priority intended network slice is URLLC, the network slice supported by the serving cell and/or the neighboring cell is URLLC being the second-priority intended network slice. In this case, the UE 100 may determine the cell reselection threshold value to be the cell reselection threshold value of Legacy or a cell reselection threshold value that facilitates cell reselection.

### Other Embodiments

In the above embodiment, the UE 100 may consider the mobility state of the UE 100, for example, whether the UE 100 is stationary or moving, when determining the network slice-specific cell reselection threshold value. The UE 100 may consider whether the UE 100 is battery powered or powered by an external power source when determining the network slice-specific cell reselection threshold value. For example, when the UE 100 is battery powered, the cell reselection threshold value may be adjusted so that the current serving cell can be easily maintained.

The operation flow (embodiment and each variation) described above can be implemented not only separately and independently, but also in combination of two or more of the operation flows. For example, some steps of one operation flow may be added to another operation flow or some steps of one operation flow may be replaced with some steps of another operation flow.

In the embodiments and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of the IAB node. The user equipment may be a Mobile Termination (MT) of the IAB node.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, system on a chip (SoC)).

Embodiments have been described above in detail with reference to the drawings, but specific configurations are not limited to those described above, and various design variation can be made without departing from the gist of the present disclosure.

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

### Supplementary Note

Features relating to the embodiment described above will be described below.

(1) A communication method performed by a user equipment in an RRC idle state or an RRC inactive state, the communication method including the steps of determining a cell reselection threshold value according to an intended network slice of the user equipment, measuring radio quality of a radio signal received by the user equipment from a network, and controlling cell reselection or cell selection according to a result of comparison between the measured radio quality and the cell reselection threshold value.

(2) The communication method according to (1) described above, wherein the cell reselection threshold value is a threshold value to be compared with the radio quality of a serving cell, and the controlling includes performing measurement in an intra-frequency and/or inter-frequency neighboring cell in response to the radio quality of the serving cell being lower than the cell reselection threshold value determined according to the intended network slice.

(3) The communication method according to (1) described above, wherein the cell reselection threshold value is a threshold value to be compared with the radio quality of an inter-frequency neighboring cell, and the controlling includes performing cell reselection to the inter-frequency neighboring cell in response to the radio quality of the inter-frequency neighboring cell being higher than the cell reselection threshold value determined according to the intended network slice.

(4) The communication method according to any of (1) to (3) described above, further including receiving, from the network, configuration information configured to determine the cell reselection threshold value, wherein the determining includes determining the cell reselection threshold value using the received configuration information.

(5) The communication method according to (4) described above, wherein the configuration information includes a plurality of network slice-specific parameters associated with respective different network slices, and the determining includes determining the cell reselection threshold value using a network slice-specific parameter associated with the intended network slice among the plurality of network slice-specific parameters.

(6) The communication method according to (5) described above, wherein each of the plurality of network slice-specific parameters includes a network slice-specific cell reselection threshold value.

(7) The communication method according to (5) described above, wherein each of the plurality of network slice-specific parameters includes a network slice-specific offset value, and a network slice-specific cell reselection threshold value is configured by applying the network slice-specific offset value to a network slice-independent cell reselection threshold value.

(8) The communication method according to (5) to (7) described above, wherein when the user equipment includes two or more intended network slices, the determining includes determining the cell reselection threshold value using two or more network slice-specific parameters associated with the two or more intended network slices.

(9) The communication method according to (4) described above, wherein the configuration information includes a representative value defining a range of the cell reselection threshold value determinable by the user equipment, and the determining includes determining, according to the intended network slice, the cell reselection threshold value within the range defined by the representative value.

(10) The communication method according to any one of (1) to (9) described above, further including receiving, from the network, support information indicating a network slice supported by a serving cell and/or a network slice supported by a neighboring cell, wherein the determining includes determining the cell reselection threshold value according to the intended network slice and the support information.

(11) A user equipment performing cell reselection or cell selection in an RRC idle state or an RRC inactive state, the user equipment including a controller configured to perform processing of determining a cell reselection threshold value according to an intended network slice of the user equipment, measuring radio quality of a radio signal received by the user equipment from a network, and controlling cell reselection or cell selection according to a result of comparison between the measured radio quality and the cell reselection threshold value.

### REFERENCE SIGNS

1: Mobile communication system
10: RAN
20: CN
50: Network
100: UE
110: Receiver
120: Transmitter
130: Controller
200: gNB
210: Transmitter
220: Receiver
230: Controller
240: Backhaul communicator

1. A communication method performed by a user equipment in an RRC idle state or an RRC inactive state, the communication method comprising the steps of:
determining a cell reselection threshold value according to an intended network slice of the user equipment;
measuring radio quality of a radio signal received by the user equipment from a network; and
controlling cell reselection or cell selection according to a result of comparison between the measured radio quality and the cell reselection threshold value.

2. The communication method according to claim 1, wherein
the cell reselection threshold value is a threshold value to be compared with the radio quality of a serving cell, and
the controlling comprises performing measurement in an intra-frequency and/or inter-frequency neighboring cell in response to the radio quality of the serving cell being lower than the cell reselection threshold value determined according to the intended network slice.

3. The communication method according to claim 1, wherein
the cell reselection threshold value is a threshold value to be compared with the radio quality of an inter-frequency neighboring cell, and
the controlling comprises performing cell reselection to the inter-frequency neighboring cell in response to the radio quality of the inter-frequency neighboring cell being higher than the cell reselection threshold value determined according to the intended network slice.

4. The communication method according to claim 1, further comprising:
receiving, from the network, configuration information configured to determine the cell reselection threshold value,
wherein the determining comprises determining the cell reselection threshold value using the received configuration information.

5. The communication method according to claim 4, wherein
the configuration information comprises a plurality of network slice-specific parameters associated with respective different network slices, and
the determining comprises determining the cell reselection threshold value using a network slice-specific parameter associated with the intended network slice among the plurality of network slice-specific parameters.

6. The communication method according to claim 5, wherein
each of the plurality of network slice-specific parameters comprises a network slice-specific cell reselection threshold value.

7. The communication method according to claim 5, wherein
each of the plurality of network slice-specific parameters comprises a network slice-specific offset value, and
a network slice-specific cell reselection threshold value is configured by applying the network slice-specific offset value to a network slice-independent cell reselection threshold value.

8. The communication method according to claim 5, wherein
when the user equipment comprises two or more intended network slices, the determining comprises determining the cell reselection threshold value using two or more network slice-specific parameters associated with the two or more intended network slices.

9. The communication method according to claim 4, wherein
the configuration information comprises a representative value defining a range of the cell reselection threshold value determinable by the user equipment, and
the determining comprises determining, according to the intended network slice, the cell reselection threshold value within the range defined by the representative value.

10. The communication method according to claim 1, further comprising:
receiving, from the network, support information indicating a network slice supported by a serving cell and/or a network slice supported by a neighboring cell,
wherein the determining comprises determining the cell reselection threshold value according to the intended network slice and the support information.

11. A user equipment performing cell reselection or cell selection in an RRC idle state or an RRC inactive state, the user equipment comprising:
a controller configured to perform processing of:
determining a cell reselection threshold value according to an intended network slice of the user equipment;
measuring radio quality of a radio signal received by the user equipment from a network; and
controlling cell reselection or cell selection according to a result of comparison between the measured radio quality and the cell reselection threshold value.
